(19) United States
(12) Patent Application Publication
(10) Pub. No.: US 2006/0235711 A1
(43) Pub. Date: Oct. 19, 2006

(54) System and method for online transaction

(76) Inventor: Chih-Yi Chen, Chung Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/193,500

(22) Filed: Aug. 1, 2005

(30) Foreign Application Priority Data
Mar. 31, 2005 (TW) 094110406

(51) Int. Cl. G06Q 99/00

(52) U.S. Cl. 705/1

(57) ABSTRACT

This invention discloses a system and a method for online transaction. The system sets a communication protocol of Digital Video Broadcasting-hand-held into a portable communication apparatus to receive and watch the multimedia commercials from a digital television provider. In addition, the system further sets a software program in the portable communication apparatus to process the transaction based on the Global System for Mobile Communication, GSM that can use the identification from Subscriber Identity Module card of the portable communication apparatus as the identification of user and the software program also can put some transaction messages or control messages into the streaming of the GSM system to as to rapidly, smoothly and automatically complete this transaction for any commercial order between the portable communication apparatus and the DTV provider.

### FIELD OF THE INVENTION

This invention generally relates to a portable communication apparatus and a digital television provider (DTV) for merchandise browsing and transactions. More particularly, the present invention relates to two communication protocols integrating into the portable communication apparatus and the DTV provider in order to satisfy information browsing and merchandise transactions.

### BACKGROUND OF THE INVENTION

Referring to FIG. 1, a block diagram of a digital television structure processing transactions is illustrated. After a television station 11 provided necessary information to a system provider 12, the necessary information are then transmitted to a set-top box 14 by satellites, cables, or radio stations as a broadcast transmitting 13. The set-top box 14 receives the necessary information and then executes decoding and an interaction program that puts the necessary information after decoded to show on a television 15. The receiver of the television 15 can select keys to make various commodities transactions by a remote control of the television 15 and the interaction programs of the set-top box 14. Afterward the internets provided by the system provider 12 implements an interaction-transmitting procedure 16 that transmits transaction data to the system provider 12. The system provider 12 delivers merchandises to the receiver according to transaction data and cooperate dealers.

Referring to FIG. 2, a block diagram of television stations providing digital multimedia data and corresponding interaction programs to system providers is illustrated. The television station 11 must provide a digital multimedia data 113 (as Motion Picture Expert Groups) and a corresponding interaction program 114 to the system provider 12. In a word, a commercial/TV program 111 can be corresponded to produce the digital multimedia data 113 through a decoder 112. While consumers browsing the digital multimedia data 113, the corresponding interaction program 114 takes the transaction activity to tell the system provider 12 for merchandise delivering.

Above transaction activities provides consumers more convenience on any transaction provided by the interaction programs 114 at any time without going outside. However, the set-top box 14 and the television 15 must be set at fixed locations. Consumers are unable to reach transaction just in time through the interaction program 114.

In addition, in current technology, the transaction activities can be used portable communication apparatus (as mobile phones) to cooperate with telecommunication providers. As shown in FIG. 3, consumers can reach wireless information transmitting by a portable communication apparatus 31 and through a station 32 established by a telecommunication provider 33. The wireless information transmitting also includes transaction messages prepared by telecommunication providers for doing the wireless communication transaction. In the wireless communication transaction, the telecommunication provider 33 relies on a default communication protocol of the portable communication apparatus 31. The telecommunication provider 33 transmits a transaction message (like simple messages) via the station 32 according to the communication protocol. The transaction message is then displayed on a panel of the portable communication apparatus 31. Consumers usually use the indication on the panel to redial or operate with computer voice for identifying with customer services of the telecommunication provider 33. The customer services or the computer voice indication will continue to fulfill each merchandise transaction.

Above wireless communication transaction gives more conveniences to consumers that there is no restriction regarding hardware arrangement. However, the merchandise information of the transaction is restricted by the communication protocol (Global System for Mobile Communication, GSM), such as bandwidth. The telecommunication provider 33 must use scripts or attach static pictures with small transmitting to form a simple message for transmitting commercials. The simple message is then transmitted to the portable communication apparatus 31 by the station 32. The portable communication apparatus 31 will accomplish a secure transaction confirmed by the telecommunication provider 33 through a bunch of procedures of identification prepared by the telecommunication provider 33. However, due to bandwidth restriction, the function of the merchandise information flow and the receive apparatus will be unable to improve.

Furthermore, as shown in FIG. 4, users can browse websites 42 connecting internets 41 via the portable communication apparatus 31 and the station 32 for making merchandise transaction. However, consumers may increase cost in wireless communication through the internets 41 for wireless transaction.

Therefore, this invention discloses a system and a method for online transaction. The condition is to set a tuner, a demodulator, and a software program into a portable communication apparatus. The portable communication apparatus may have a low power receiving and play the multimedia commercial information provided by digital TV providers. Users can use the keys of the portable communication apparatus through an original communication protocol of the portable communication apparatus with a software program to automatic implement a personal identification with the digital TV providers and related transaction activities.

### SUMMARY OF THE INVENTION

The primary object of the present invention is to provide a system and a method for online transaction by establishing a tuner into the portable communication apparatus. Consumers can watch multimedia commercial information provided by digital television providers in order to resolve the restrictions regarding the hardware arrangement and the digital interactive TV environments.

In addition, the establishment of the tuner can resolve the restrictions regarding the communication protocol and the bandwidth between the portable communication apparatus and the telecommunication providers to cause the telecommunication providers that just can merely deliver scripts and attach static pictures to describe merchandise information. The consequence is that consumers reduce desires for online transaction via the portable communication apparatus.

Moreover, the establishment of the tuner can reduce the wireless communication cost between the portable communication apparatus and the telecommunication providers during the online transaction activity of the wireless communication.

The second object of the present invention is to provide a system and a method for online transaction by establishing a software program into the portable communication apparatus. Consumers can watch multimedia commercial information provided by digital television providers through the keys and the chip identification code in the portable communication apparatus that automatically finishes the online personal identification and the online transaction in order to avoid the merchandise transaction in the prior art that is too complex.

The third object of the present invention is to integrate a tuner and a software program into a portable communication apparatus in order to improve the completeness and the smoothness in transaction activities.

The fourth object of the present invention is to effective integrate a first communication protocol (as a Digital Video Broadcasting-hand-held, DVB-H) and a second communication protocol (as a Global System for Mobile Communication, GSM) via a software program provided by the invention. The portable communication apparatus can use the first communication protocol and a transaction server (as a digital television server) to transmit for watching (as a merchandise message of a commercial). In addition, the portable communication apparatus can use above the second communication protocol and above the transaction server to transmit a transaction message or a transaction of a control message or a merchandise browsing commands.

The fifth object of the present invention is to take transaction messages or control messages to embed into a signal flow of the GSM through a chip identification code of a SIM card in order to automatic finish the transaction activity with the merchandise ordering and browsing.

### BRIEF DESCRIPTION OF THE DRAWINGS

FIG. 1 is a block diagram of a digital television structure processing transactions;

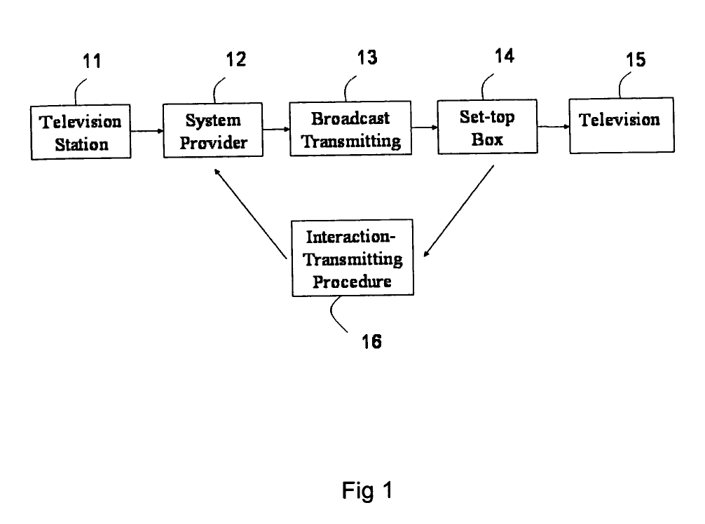

FIG. 2 is a block diagram of television stations providing digital multimedia data and corresponding interaction programs to system providers;

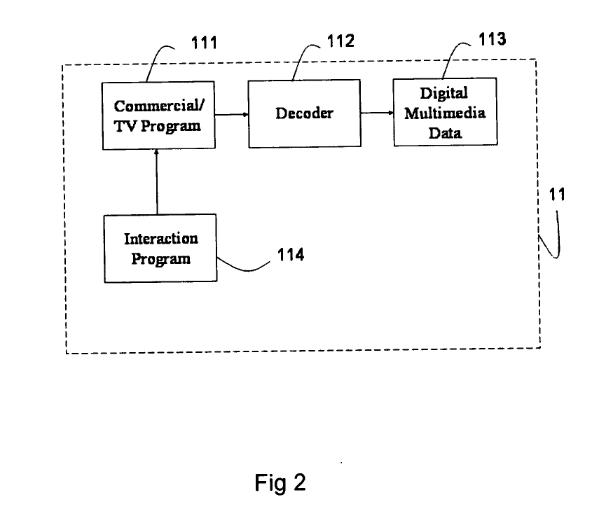

FIG. 3 is a schematic view of using a portable communication apparatus and cooperating with a telecommunication provider for making transaction;

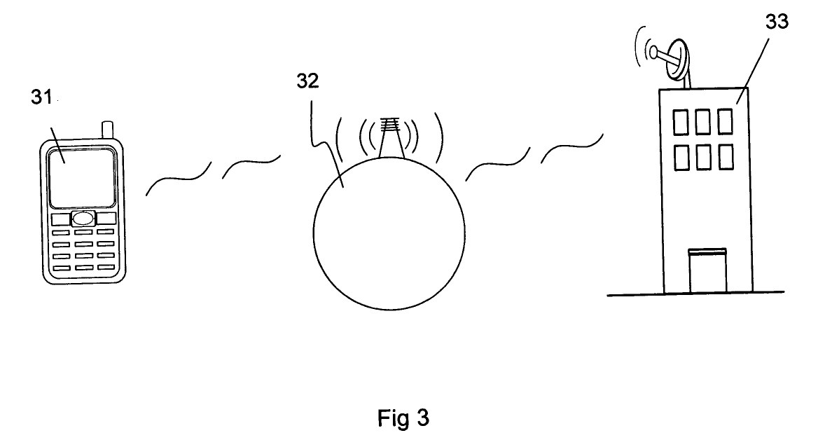

FIG. 4 is a schematic view of using a portable communication apparatus and cooperating with a telecommunication provider for making internet transaction;

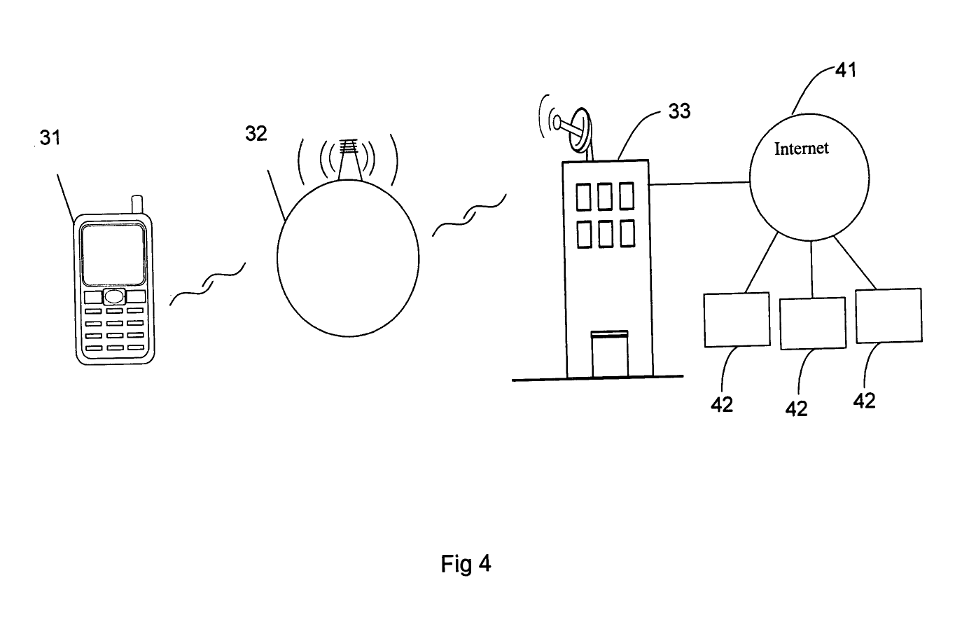

FIG. 5 is a block diagram of an example of an online transaction system according to an embodiment of the present invention;

FIG. 6 is a block diagram of an example of a portable communication apparatus according to an embodiment of the present invention;

FIG. 7 is another block diagram of an example of a portable communication apparatus according to an embodiment of the present invention;

FIG. 8 is a structural diagram of an example of a receiving system of a Digital Video Broadcasting-hand-held, DVB-H according to an embodiment of the present invention;

FIG. 9 is a structural diagram of an example of an inside system of a portable communication apparatus according to an embodiment of the present invention; and

FIG. 10 is a flowchart of an example of an online transaction method according to an embodiment of the present invention.

### DETAILED DESCRIPTION OF THE PREFERRED EMBODIMENTS

Preferred embodiments of the present invention will be explained below with reference to the drawing.

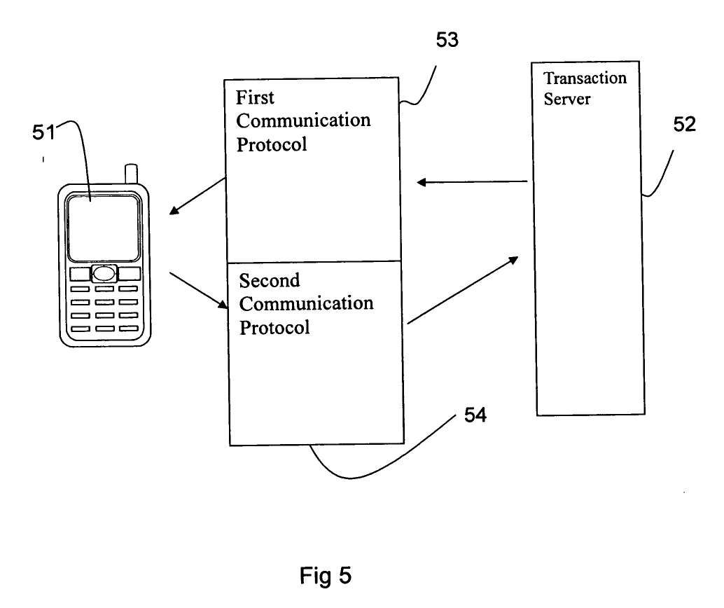

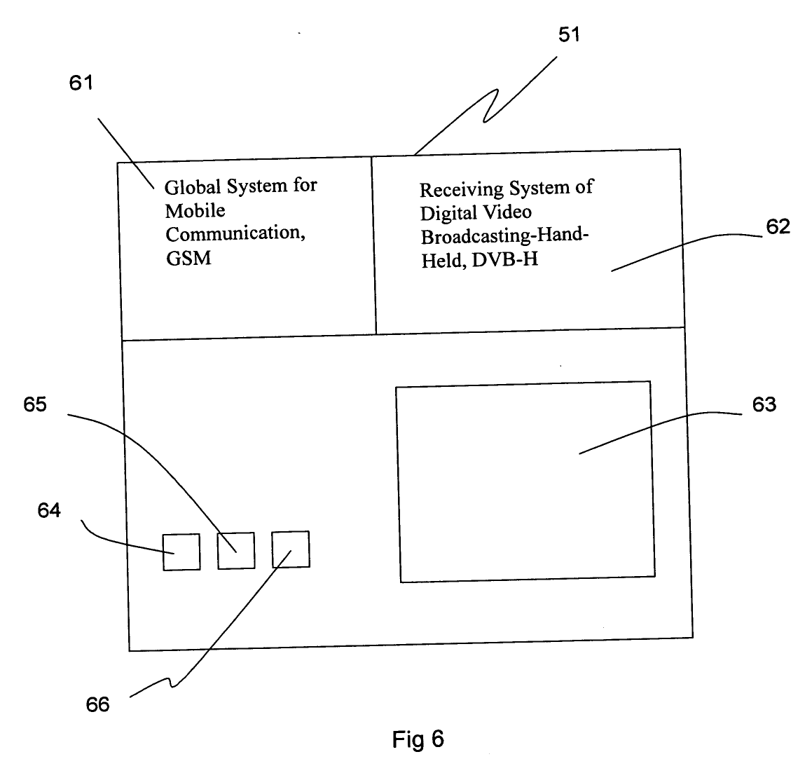

Referring to FIG. 5 and FIG. 6, an implementation diagram of an online transaction system of an example according to an embodiment of present invention and an implementation diagram of a portable communication apparatus of an example according to an embodiment of present invention are illustrated. As shown in FIG. 5, the online transaction system comprises a portable communication apparatus 51 (like a mobile phone), a transaction server 52 (like a digital television server), a first communication protocol 53 (like a protocol of a Digital Video Broadcasting-hand-held, DVB-H), and a second communication protocol 54 (like a protocol of a Global System for Mobile Communication, GSM).

The portable communication apparatus 51 and a digital television server of the transaction server 52 are to take a merchandise message of a multimedia provided by a digital television provider for delivering to the portable communication apparatus 51 through a protocol of the DVB-H of the first communication protocol 53. Users can watch commercials of a digital television via the portable communication apparatus 51. As shown in FIG. 6, if users would like to directly operate the portable communication apparatus 51 for making the merchandise transactions or selecting merchandise items, they can use confirm keys or selection keys on mobile phones to deliver data flow to the digital television server of the transaction server 52 in order to accomplish the merchandise transactions or TV control through a protocol of the GSM of the second communication protocol 54.

Referring to FIG. 6, the portable communication apparatus 51 comprises at least one GSM 61 and a receiving system of a DVB-H 62. The function keys of the portable communication apparatus 51 comprise default operation keys. The operation keys are a confirm key 64, a front view key 65, and a back view key 66. In addition, the portable communication apparatus 51 further sets or integrates a display 63 to watch multimedia merchandise messages delivered by the transaction server 52 as a digital television server).

The portable communication apparatus 51 comprises two communication protocols. The receiving system of a DVB-H 62 is set into the portable communication apparatus 51 to receive or transmit the merchandise message of the transaction server 52 as main communication protocol.

By way of the communication protocol, the transaction server 52 uses a wireless transmitting that takes digital video and voice data 113 to the portable communication apparatus 51 as the invention disclosed. The portable communication apparatus 51 uses the front view key 65 and the back view key 66 that takes control commands of selections of merchandise items to embed into a data flow of the second communication protocol 54 (as a protocol of GSM) through the GSM 61. When the transaction server 52 (as a digital television server) receives the data flow, the data flow must be decode and demodulate according to above control commands for transmitting a corresponding broadcast of commercials through the first communication protocol 53 (as a protocol of a DVB-H). The above commercials are a digital video and voice data 113 (such as: Motion Pictures Experts Group, MPEG H.264, H.263, or Microsoft WM9). After decoded, the digital video and voice data 113 can be broadcasted on the display panel 63 of the portable communication apparatus 51 for watching.

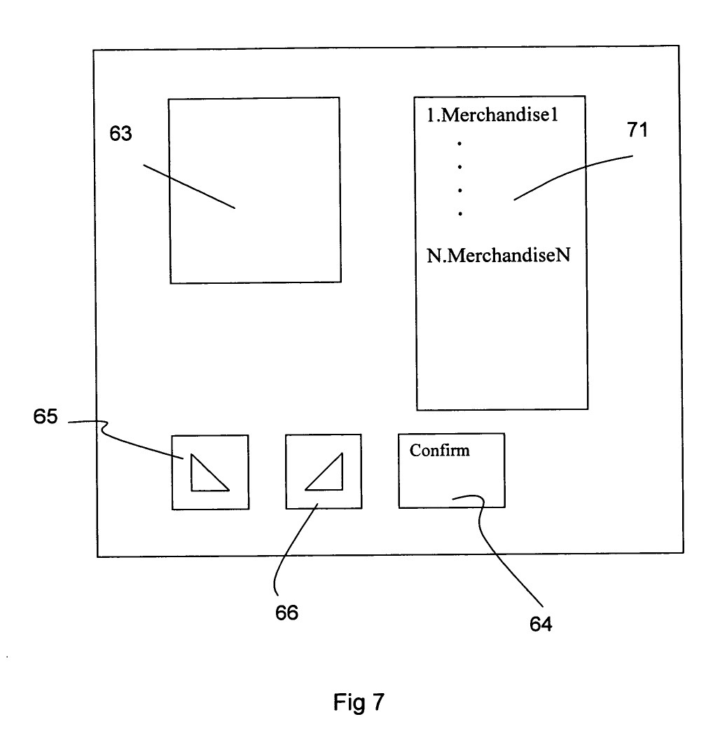

Referring to FIG. 7, another block diagram of a portable communication apparatus of an example according to an embodiment of the present invention is illustrated. The function of the front view key 65 and the back view key 66 is used for browsing next digital information and is also used for selecting merchandise messages listed by another display 71 of the portable communication apparatus 51. At the same time, the display 63 of the portable communication apparatus 51 can broadcast above selected merchandise messages. While browsing the merchandise message, a user can use the confirm key 64 of the portable communication apparatus 51 to confirm the purchased merchandise. Above the confirm key 64 of the portable communication key 51 is to accomplish merchandise transaction activities provided by the transaction server 52 through the GSM 61.

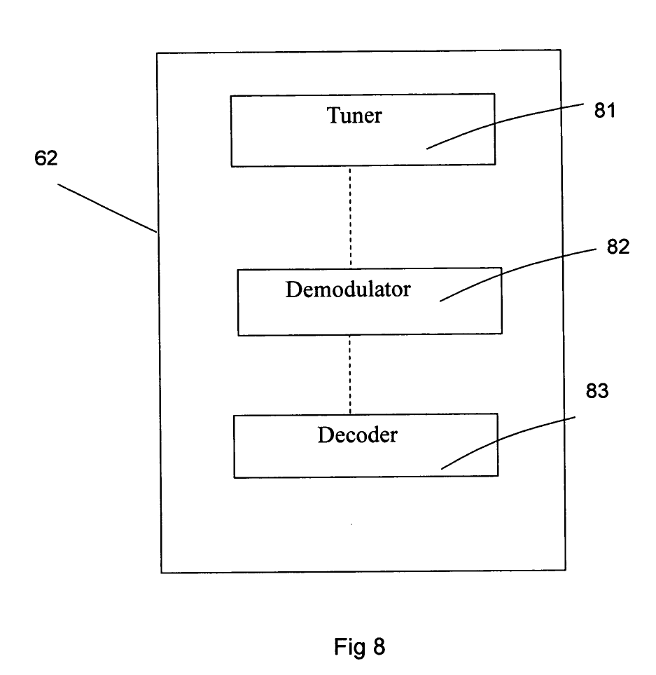

Referring to FIG. 8 and referring to FIG. 5, FIG. 6, and FIG. 7, a structural diagram of a receiving system of a Digital Video Broadcasting-hand-held, DVB-H according to an embodiment of present invention is illustrated. The receiving system 62 comprises a tuner 81, a demodulator 82, and a decoder 83. After the tuner 81 receives a merchandise message of the transaction server 52, the merchandise message must demodulate and the decoder 83 then decodes the demodulated merchandise message to be a format that can be broadcasted on the portable communication apparatus 51.

While the display 63 is playing, the GSM 61 in the portable communication apparatus 51 implements a transaction communication of the transaction server 52 immediately after a user presses the confirm key 64. The corresponding code of the confirm key 64 is embedded into a data flow of above the transaction communication in order to provide the transaction server 52 for determining the merchandise transaction. In addition, the transaction server 52 can do a personal identification through a Subscriber Identity Module (SIM) of the portable communication apparatus 51 and related telecommunication providers. The transaction server 52 can cooperate with related telecommunication providers that take merchandise transaction amount for merging into the communication fees of the portable communication apparatus 51 in order to avoid the transaction data giving away.

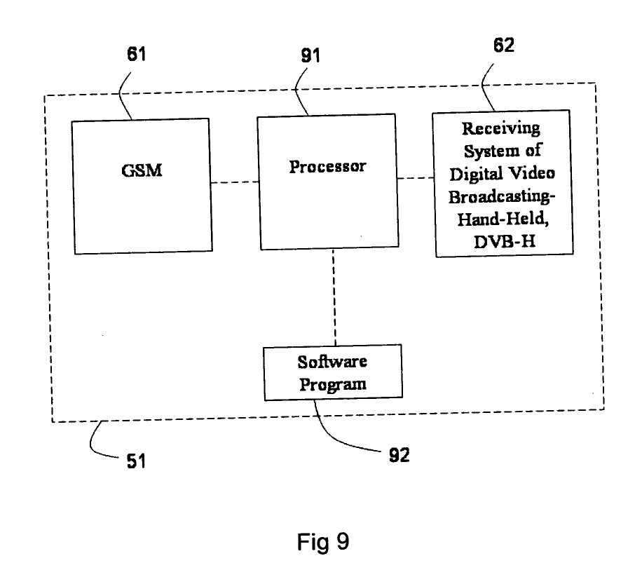

In order to take the portable communication apparatus 51 and the receiving system of the DVB-H 62 to be protected and applied into the system as the invention disclosed, FIG. 9 shows through a processor 91 of the portable communication apparatus 51 and a software program 92 for providing an application and a switch between above the GSM 61 and the receiving system of the DVB-H 62.

Above the software program 92 can include the designing of above the operation interface activity and above the transaction message that embeds into a GSM data flow. In addition, the demodulator 82 and the decoder 83 can cooperate with the processor 91 of the portable communication apparatus 51 for implementing via the software program 92.

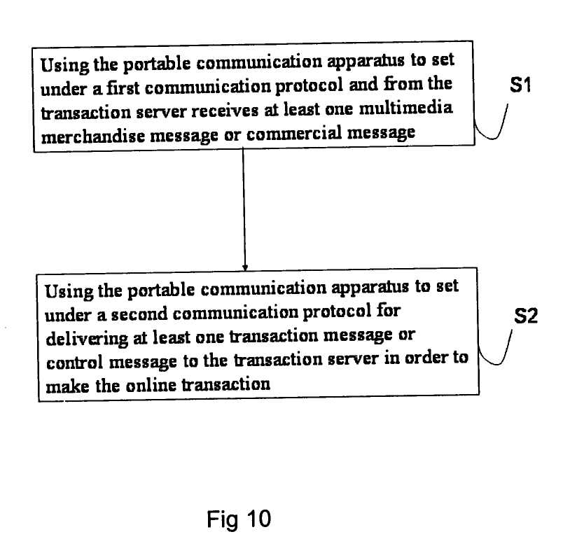

According to the system as the invention disclosed, FIG. 10 shows an online transaction method and the method comprises following steps:
Step S1: Using the portable communication apparatus 51 to set under a first communication protocol 53 and from the transaction server 52 receives at least one multimedia merchandise message or commercial message.
Step S2: Using the portable communication apparatus 51 to set under a second communication protocol 54 for delivering at least one transaction message or control message to the transaction server in order to make the online transaction.

The security of the online transaction can use an identification code of a SIM card of the portable communication apparatus 51 to accomplish from the transaction server 52 cooperating with related telecommunication providers.

In summation of the description above, the present invention is novel and useful and definite enhances the performance over the conventional structure and further complies with the patent application requirements and is submitted to the Patent and Trademark Office for review and granting of the commensurate patent rights.

What is claimed is:

1. A online transaction system, comprising:
a portable communication apparatus, being under a first communication protocol for receiving at least one merchandise message and being under a second communication protocol for delivering at least one transaction message; and
a transaction server, being under said first communication protocol for delivering said merchandise message and being under said second communication protocol for receiving said transaction message.

2. The online transaction system of claim 1, wherein said portable communication apparatus is a mobile phone.

3. The online transaction system of claim 1, wherein said first communication protocol is a Digital Video Broadcasting-hand-held, DVB-H.

4. The online transaction system of claim 1, wherein said second communication protocol is a Global System for Mobile Communication, GSM.

5. The online transaction system of claim 1, wherein said merchandise message is a commercial message.

6. The online transaction system of claim 5, wherein said commercial message is a multimedia data.

7. The online transaction system of claim 1, wherein said transaction message is a control message.

8. The online transaction system of claim 1, wherein said transaction server is a digital television server.

9. A portable communication apparatus, being used with a transaction server for making a online transaction, at least comprising:
a receiving unit, being under a first communication protocol, from said transaction server receiving at least one merchandise message; and
a delivering unit, being under a second communication protocol for delivering at least one transaction message to said transaction server in order to make said online transaction.

10. The portable communication apparatus of claim 9, wherein said transaction message is a control message.

11. The portable communication apparatus of claim 9, wherein said transaction server is a digital television server.

12. A online transaction platform, being applied with a portable communication apparatus for making a online transaction, at least comprising:
delivering unit, being under a first communication protocol for delivering at least one merchandise message to said portable communication apparatus; and
a receiving unit, being under a second communication protocol, from said portable communication apparatus receiving at least one transaction message for making said online transaction.

13. The online transaction platform of claim 12, wherein said online transaction platform is a digital television server.

14. A online transaction method, being applied with a transaction server for making a online transaction, at least comprising:
using a portable communication apparatus to set under a first communication protocol, from said transaction server receiving at least one merchandise message; and
using said portable communication apparatus to set under a second communication protocol for delivering at least one transaction message to said transaction server in order to make said online transaction.

15. The online transaction method of claim 14, further comprising a Digital Video Broadcasting-hand-held, DVB-H to be said first communication protocol.

16. The online transaction method of claim 14, further comprising a Global System for Mobile Communication, GSM to be said second communication protocol.

17. The online transaction method of claim 14, further comprising a commercial message to be said merchandise message.

18. The online transaction method of claim 14, further comprising a control message to be said transaction message.

19. The online transaction method of claim 14, further comprising a digital television server to be said transaction server.

20. The online transaction method of claim 14, further comprising a chip identification code of said portable communication apparatus to make a personal identification during delivering said transaction message.
